(19) United States
(12) Patent Application Publication
(10) Pub. No.: US 2009/0216634 A1
(43) Pub. Date: Aug. 27, 2009

(54) APPARATUS, COMPUTER-READABLE STORAGE MEDIUM AND METHOD FOR PROVIDING A WIDGET AND CONTENT THEREFOR

(75) Inventors: Taneli Peltonen, Espoo (FI); Antti Heinonen, Espoo (FI); Otto Pulkkinen, Helsinki (FI); Seppo Pyhalammi, Helsinki (FI); Antti Inkeroinen, Espoo (FI); Jani Flink, Vantaa (FI); Samuli Sillanpaa, Helsinki (FI); Simo Tuokko, Helsinki (FI); Pasi Hamalainen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/037,976

(22) Filed: Feb. 27, 2008

(51) Int. Cl. G06Q 30/00; G06F 15/16

(52) U.S. Cl. 705/14; 709/218

(57) ABSTRACT

An apparatus is provided and includes a processor that is configured to display an advertisement for an advertised widget on a standby screen presented by a display when the apparatus is in a standby state. The processor is configured to receive selection of the presented advertisement and, in response thereto, receive and install the advertised widget in response to receiving the selection. The processor is then configured to display an item of content provided by the installed, advertised widget on the standby screen when the apparatus is in the standby state.

### FIELD OF THE INVENTION

The present invention generally relates to systems and methods of providing widgets to a terminal, and more particularly, relates to one or more of advertising for widgets and subsequent provision of widgets on a standby screen, as well as adding widgets to and/or moving widgets around a dashboard, or providing Intranet content through a widget.

### BACKGROUND OF THE INVENTION

Electronic access to and distribution of information has grown in importance as a result of networks such as the Internet connecting individuals on a global scale. Even individuals who are on travel or vacation may connect to communication and information networks through mobile communication devices like mobile telephones. For example, many smartphones allow users to browse the web, check and send e-mails or other electronic messages and make telephone calls while they are on the move. Business people, in one instance, may use such devices to seek information involving business news, stock prices and/or weather reports. From a social perspective, information access may further be directed toward obtaining gossip information, web logs (i.e., blogs) and/or traffic alerts.

Typically, an individual must access desired information by manually navigating to a particular site and/or manually searching for the topic of interest. For example, a mobile device user interested in up-to-date stock quotes may enter a particular stock quote web address into a browser and subsequently enter the stock symbol or symbols. In another example, an individual who does not know where to access stock information may enter a search website address to search for stock quotes. The individual may then be required to parse through multiple search results to find a suitable web site. In either case, an individual may have to take several steps before receiving the information they desire.

In an effort to overcome a number of the aforementioned drawbacks, user interface elements commonly referred to as “widgets” have been developed to provide information to users in a more convenient manner. In this regard, a widget may be considered a downloadable, interactive virtual tool (software tool) that provides content such as headline news, exchange rates, sports results, stock quotes, weather forecasts, multilingual phrase dictionaries, encyclopedias, maps, entertainment listings, personal online calendars, or the like to a user. But although widgets may overcome a number of the aforementioned drawbacks, it is usually desirable to improve upon existing technologies, including those related to widgets such as to further improve widget user experience.

### SUMMARY OF THE INVENTION

In light of the foregoing background, embodiments of the present invention provide an improved apparatus, method and computer-readable storage medium and method for providing widgets and content therefor. According to one aspect of exemplary embodiments of the present invention, an apparatus is provided and includes a processor that is configured to display an advertisement for an advertised widget on a standby screen presented by a display when the apparatus is in a standby state, such as when the apparatus is switched on or in an idle state. The processor may be configured to selectively display an advertisement from a plurality of advertisements for a respective plurality of advertised widgets. The processor is configured to receive selection of the presented advertisement and, in response thereto, receive and install the advertised widget in response to receiving the selection. The processor is then configured to display an item of content provided by the installed, advertised widget on the standby screen when the apparatus is in the standby state. In this regard, the processor may be configured to display the item of content in a minimized view, where the advertised widget may be selectable to display content provided by the advertised widget in a maximized view.

The processor may be further configured to display indicia for the advertised widget on a dashboard presented by the display, where the indicia may be displayed after installation of the advertised widget, and where the dashboard may include indicia for each of a plurality of widgets. In one exemplary embodiment, these indicia may be referred to as a “web icons.” Thus, the apparatus may have another widget installed thereon. In such instances, the processor may be further configured to add the other widget to the standby screen. The processor may then be configured to selectively display an item of content provided by the advertised widget or other widget on the standby screen when the apparatus is in the standby state.

According to one aspect of exemplary embodiments of the present invention, an apparatus is provided and includes a processor that is configured to receive, from a widget installed on a remote apparatus, an indication of the widget coming on-line. The processor is of the other apparatus configured to identify the widget as being configured to provide content from a source located within an Intranet and, in response to the identifying, communicate with a network entity of the Intranet to authenticate the widget to receive the content. Then, if the widget is authenticated, the processor of the other apparatus is configured to receive the content from the source, and deliver the content to the widget for display on the apparatus.

The processor being configured to communicate with the network entity may include being configured to sign a network address of the content with a software token of the widget and, if so desired, a cryptographic key of a cryptographic scheme implemented with the network entity. The processor may then be configured to send a request for the content to the network entity of the Intranet, where the request may include the signed network address, and may enable the network entity to verify the signed network address to thereby authenticate the widget.

According to other aspects of the present invention, computer-readable mediums and methods are provided. Exemplary embodiments of the present invention therefore provide an improved apparatus, method and computer-readable storage medium for providing widgets and content therefor. As indicated above, and explained below, exemplary embodiments of the present invention may solve problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one exemplary embodiment of the present invention including a cellular network and a data network to which a terminal is bi-directionally coupled through wireless RF links;

FIG. 2 is a schematic block diagram of an entity configured to operate as a terminal, server and/or client, in accordance with exemplary embodiments of the present invention;

FIG. 3 is a more particular schematic block diagram of a terminal, according to exemplary embodiments of the present invention;

FIG. 4 is a functional block diagram of a system for providing widgets to a terminal, according to exemplary embodiments of the present invention;

FIGS. 5a and 5b are functional block diagrams of the display of a terminal presenting a dashboard on which one or more widgets may be situated or otherwise positioned, according to exemplary embodiments of the present invention;

FIGS. 6a and 6b are functional block diagrams of the display of a terminal presenting an opened widget in a minimized view or a maximized view, respectively, according to exemplary embodiments of the present invention;

FIGS. 7a-7f graphically illustrate by way of presentations of the display of the terminal a method for adding a new widget to the dashboard, according to one exemplary embodiment of the present invention;

FIGS. 8a-8g graphically illustrate by way of presentations of the display of the terminal a method for adding a new widget to the dashboard, according to another exemplary embodiment of the present invention;

FIGS. 9a-9c graphically illustrate by way of presentations of the display of the terminal a method for repositioning a widget within the area of a dashboard for presenting widgets, according to one exemplary embodiment of the present invention;

FIG. 10 is a functional block diagram of a system for providing, to a terminal, widgets including advertisements for associated widgets, according to exemplary embodiments of the present invention;

FIG. 11 is a flowchart including various steps in a method of providing, to a terminal, widgets including advertisements for associated widgets, according to exemplary embodiments of the present invention;

FIGS. 12, 13, 14 and 15 are graphic illustrations of the display of a terminal, according to exemplary embodiments of the present invention;

FIG. 16 is a functional block diagram of a system for creating or otherwise setting up a widget to provide content from an Intranet widget source, and thereafter providing content from that source, according to exemplary embodiments of the present invention; and

FIGS. 17 and 18 are flowcharts including various steps in a method of creating or otherwise setting up a widget to provide content from an Intranet widget source, and thereafter providing content from that source, according to exemplary embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

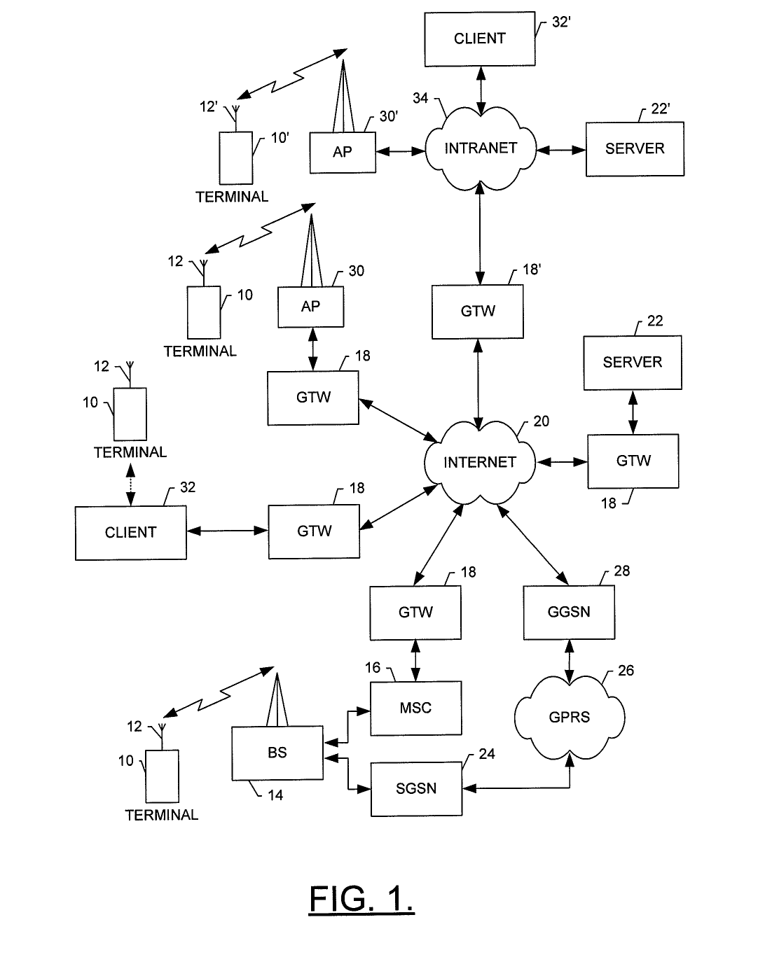

Referring to FIG. 1, an illustration of one type of terminal and system that would benefit from the present invention is provided. The system, method and computer program product of exemplary embodiments of the present invention will be primarily described in conjunction with mobile communications applications. It should be understood, however, that the system, method and computer program product of exemplary embodiments of the present invention may be utilized in conjunction with a variety of other applications, both in the mobile communications industries and outside of the mobile communications industries. For example, the system, method and computer program product of exemplary embodiments of the present invention may be utilized in conjunction with wireline and/or wireless network (e.g., Internet) applications.

As shown, a terminal 10 (mobile client) may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI). In operation, the MSC is configured to route calls and messages to and from the terminal when the terminal is making and receiving calls. The MSC also provides a connection to landline trunks when the terminal is involved in a call.

The MSC 16 may be coupled to one or more data networks, such as one or more local area networks (LANs), metropolitan area networks (MANs), and/or wide area networks (WANs). The MSC may be directly coupled to the data network. In one typical embodiment, however, the MSC is coupled to a server gateway (GTW) 18, and the GTW is coupled to a WAN, such as the Internet 20. In turn, devices such as processing elements (e.g., personal computers, server computers or the like) may be coupled to the terminal 10 via the Internet. For example, the processing elements may include one or more processing elements associated with one or more servers 22 or the like, one of which being illustrated in FIG. 1.

In addition to or in lieu of the cellular network, the BS 14 may be part of a packet-switched core network, such as a GPRS core network. In this regard, the BS may be coupled to a signaling GPRS (General Packet Radio Service) support node (SGSN) 24. The SGSN may be configured to perform functions similar to the MSC 16 for packet-switched services. The SGSN, like the MSC, may be coupled to a data network, such as the Internet 20. The SGSN may be directly coupled to the data network. In a more typical embodiment, however, the SGSN is coupled to a packet-switched core network, such as a GPRS core network 26. The packet-switched core network is then coupled to another GTW, such as a GTW GPRS support node (GGSN) 28 (note that a GGSN may at times herein be referred to as a GTW 18), and the GGSN is coupled to the Internet.

In addition to or in lieu of being coupled to the BS 14, the terminal 10 may be coupled to one or more wireless access points (APs) 30. The APs may be configured to communicate with the terminal in accordance with techniques such as, for example, radio frequency (RF), Bluetooth (BT), infrared (IrDA) or any of a number of different wireless networking techniques, including WLAN techniques. Additionally, or alternatively, the terminal may be coupled to one or more clients 32 (web clients). Each client may comprise a computing system such as personal computers, laptop computers or the like. In this regard, the clients may be configured to communicate with the terminal in accordance with techniques such as, for example, RF, BT, IrDA or any of a number of different wireline or wireless communication techniques, including LAN and/or WLAN techniques. One or more of the clients may additionally, or alternatively, include a removable memory configured to store content, which may thereafter be transferred to the terminal.

The APs 30 and the processors 30 may be coupled to the Internet 20. Like with the MSC 16, the APs and clients may be directly coupled to the Internet. In one advantageous embodiment, however, the APs and clients are indirectly coupled to the Internet via a GTW 18. As will be appreciated, by directly or indirectly connecting the terminals and the server 22, as well as any of a number of other devices, to the Internet, the terminals may communicate with one another, the server, etc., to thereby carry out various functions of the terminal, such as to transmit data, content or the like to, and/or receive content, data or the like from, the server. As used herein, the terms “data,” “content,” “information” and similar terms may be used interchangeably to refer to data configured to be transmitted, received and/or stored in accordance with exemplary embodiments of the present invention. This content may include, for example, multimedia content with audio, video, textual and/or graphical portions. Thus, use of any such terms should not be taken to limit the spirit and scope of the present invention.

In accordance with embodiments of the present invention, the Internet 20, and thus the terminal 10, may be coupled to one or more Intranets 34, one of which is illustrated in FIG. 1. Each Intranet generally comprises a private network, and may include one or more interlinked LANs, and may also (but need not) include portions of one or more wireline and/or wireless LANs, MANs, WANs or the like. It should therefore be understood that an Intranet may comprise any of a number of private networks that may include portions owned or otherwise controlled by the same entity, but that may also include portions owned or otherwise controlled by other entities. As with the Internet, devices such as terminals, processing elements (e.g., server(s) 22, client(s) 32, etc.) may be coupled to the Intranet, and thus the Internet and terminal, via the Intranet. The devices may be directly coupled to the Intranet, or coupled to the Intranet via one or more server gateways, such as between interlinked LANs of the Intranet. As shown in the figures and explained herein, reference numerals generally refer to network entities both within and outside an Intranet, but reference numerals with prime notations (e.g., server 22′, client 32′, GTW 18′, etc) refer to network entities within or in direct communication with an Intranet particularly—although these entities may also be configured to communicate outside the respective Intranet.

Like various other components of the system, the Intranet 34, and thus the processing elements of the Intranet, is typically indirectly coupled to the Internet 20, and thus the terminal 10, via one or more gateways 18 (and/or APs 30), one or more of which may implement a firewall between the Intranet and Internet. Similarly, although not shown, each network or portion of a network included within the Intranet may be interconnected with one another via a gateway. As explained below, a terminal is capable of accessing the Intranet, and thus processing elements (e.g., server(s) 22, client(s) 32, etc.) coupled to the Intranet, by establishing a Virtual Private Network (VPN) or other secure tunnel (e.g., IPSec, SSL/TLS, etc.) across the gateway to the Intranet, and if so required, across one or more other gateways within the Intranet. In such instances, then, the gateway coupling the Intranet and Internet may be referred to as a VPN GTW.

As shown and described above, a terminal 10 may be configured to access the Internet 20, and thus the Intranet 34, in any of a number of different manners. For example, a terminal may be configured to access the Internet via an AP 30 and/or client 32. Additionally or alternatively, a terminal may be configured to access the Internet via the MSC 16, such as to provide circuit-switched connectivity. Further, the terminal may be additionally or alternatively configured to access the Internet via the SGSN 24, such as to provide circuit or packet-switched connectivity across the GPRS core network 26. As used herein, the network entities or components by which a terminal may be configured to access the Internet may be referred to as “Internet Access Points” or IAPs. Although a terminal may access the Internet via any one or more of the aforementioned IAPs, it should be understood that the above IAPs are merely illustrative of the number of different IAPs by which the terminal may be capable of accessing the Internet.

Although not every element of every possible mobile network is shown and described herein, it should be appreciated that the terminal 10 may be coupled to one or more of any of a number of different networks. In this regard, the network(s) may be configured to support communication in accordance with any one or more of a number of first-generation (1G), second-generation (2G), 2.5G and/or third-generation (3G) mobile communication protocols or the like. For example, one or more of the network(s) may be configured to support communication in accordance with 2G wireless communication protocols IS-136 (TDMA), GSM, and IS-95 (CDMA). Also, for example, one or more of the network(s) may be configured to support communication in accordance with 2.5G wireless communication protocols GPRS, Enhanced Data GSM Environment (EDGE), or the like.

Also, for example, one or more of the network(s) may be configured to support communication in accordance with 3G wireless communication protocols such as Universal Mobile Telephone System (UMTS) network employing Wideband Code Division Multiple Access (WCDMA) radio access technology. Further, for example, one or more of the network(s) may be additionally or alternatively configured to support communication in accordance with any of a number of different digital broadcasting and/or multicasting techniques, such as DVB (e.g., DVB-T, ETSI Standard EN 300 744), MBMS (e.g., 3GPP TS 22.146) techniques or the like. Even further, for example, one or more of the network(s) may be additionally or alternatively configured to support communication in accordance with ISDB-T, DAB, ATSC techniques or the like. The network(s) may even be configured to support communication of some narrow-band AMPS (NAMPS), as well as TACS, terminals, as well as dual or higher mode terminals (e.g., digital/analog or TDMA/CDMA/analog phones).

Referring now to FIG. 2, a block diagram of an entity configured to operate as one or more of a terminal 10, server 22 or client 32 is shown in accordance with one exemplary embodiment of the present invention. Although shown as separate entities, in some embodiments, one or more entities may support one or more of a terminal, server or client, logically separated but co-located within the entit(ies). For example, a single entity may support a logically separate, but co-located, terminal and client. Also, for example, a single entity may support a logically separate, but co-located server and client.

The entity configured to operate as one or more of a terminal 10, server 22 or client 32 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity may include a processor 38 connected to a memory 40. The memory may comprise volatile and/or non-volatile memory, and typically stores content, data or the like. For example, the memory typically stores content transmitted from, and/or received by, the entity. Also, for example, the memory typically stores software applications, instructions or the like for the processor to perform functions associated with operation of the entity in accordance with exemplary embodiments of the present invention.

The software applications stored by the memory 40 may include, for example, one or more widgets for providing content such as headline news, exchange rates, sports results, stock quotes, weather forecasts, multilingual phrase dictionaries, encyclopedias, maps, entertainment listings, personal online calendars, or the like to a user. In a more particular example, one or more widgets may provide messaging-related content for one or more messaging applications (e.g., e-mail, SMS, MMS, IM, etc.) including, for example, notifications of incoming messages, numbers of unread messages or the like, and may interface with one or more of these applications for provision of one or more messaging functions to the user. Further, for example, the memory may store (or the network entity may otherwise be in communication with) one or more databases of information, such as database(s) of widgets and, if so desired, information appropriate for administering a service for collecting widgets and/or widget content from one or more other widget sources, and providing the collected widgets/content to clients.

Although described herein as being implemented in software application(s), it should be understood that any one or more of the functions described herein may alternatively be implemented in firmware or hardware, without departing from the spirit and scope of the present invention. Generally, then, the terminal 10, server 22 or client 32 may include one or more logic elements for performing various functions. As will be appreciated, the logic elements may be embodied in any of a number of different manners. In this regard, the logic elements performing the respective functions may be embodied in an integrated circuit assembly including one or more integrated circuits integral or otherwise in communication with a respective network entity (i.e., terminal, server, client, etc.) or more particularly, for example, a processor 38 of the respective network entity.

In addition to the memory 40, the processor 38 may also be connected to at least one interface or other means for displaying, transmitting and/or receiving data, content or the like. In this regard, the interface(s) may include at least one communication interface 42 or other means for transmitting and/or receiving data, content or the like, as well as at least one user interface that may include a display 44 and/or a user input interface 46. The user input interface, in turn, may comprise any of a number of devices allowing the entity to receive data from a user, such as a keypad, a touch display, a joystick or other input device. As more particularly explained below, for example, the user input interface may include one or more directional keys (hard and/or soft keys) for directionally selecting items.

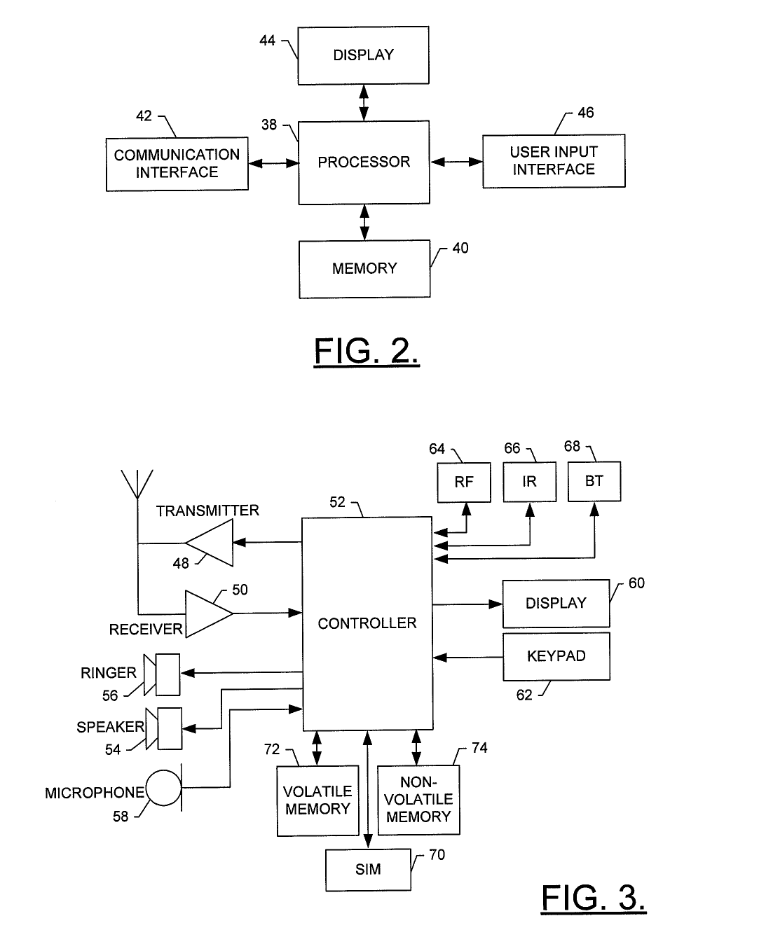

FIG. 3 illustrates a more particular functional diagram of a terminal 10, according to exemplary embodiments of the invention. It should be understood, that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as portable digital assistants (PDAs), pagers, laptop computers and other types of voice and text communications systems, may readily employ the present invention.

The terminal 10 includes various means for performing one or more functions in accordance with exemplary embodiments of the present invention, including those more particularly shown and described herein. It should be understood, however, that the terminal may include alternative means for performing one or more like functions, without departing from the spirit and scope of the present invention. More particularly, for example, as shown in FIG. 3, the terminal may include a transmitter 48, a receiver 50, and a controller 52 or other processor that provides signals to and receives signals from the transmitter and receiver, respectively. These signals include signaling information in accordance with the air interface standard of the applicable cellular system, and also user speech and/or user generated data. In this regard, the terminal may be configured to operate with one or more air interface standards, communication protocols, modulation types, and access types. More particularly, the terminal may be configured to operate in accordance with any of a number of 1G, 2G, 2.5G and/or 3 G communication protocols or the like. The terminal may additionally or alternatively be configured to operate in accordance with any of a number of different digital broadcasting and/or multicasting techniques. Further, the terminal may be configured to operate in accordance with ISDB-T, DAB, ATSC techniques or the like. Some narrow-band AMPS (NAMPS), as well as TACS, terminals may also benefit from embodiments of the present invention, as should dual or higher mode terminals (e.g., digital/analog or TDMA/CDMA/analog phones).

It is understood that the controller 52 includes the circuitry required for implementing the audio and logic functions of the terminal. For example, the controller may be comprised of a digital signal processor device, a microprocessor device, and various analog to digital converters, digital to analog converters, and other support circuits. The control and signal processing functions of the terminal are allocated between these devices according to their respective capabilities. The controller thus also includes the functionality to convolutionally encode and interleave message and data prior to modulation and transmission. The controller may additionally include an internal voice coder (VC), and may include an internal data modem (DM). Further, the controller may include the functionally to operate one or more software applications, which may be stored in memory.

The terminal also comprises a user interface including a conventional earphone or speaker 54, a ringer 56, a microphone 58, a display 60, and a user input interface, all of which are coupled to the controller 52. The user input interface, which allows the terminal to receive data, may comprise any of a number of devices allowing the terminal to receive data, such as a keypad 62, a touch display (not shown) or other input device. In embodiments including a keypad, the keypad includes the conventional numeric (0-9) and related keys (#, *), and other keys used for operating the terminal. For example, the keypad may additionally or alternatively include directional keys (↑, →, ↓, ←) for directionally selecting items.

The terminal 10 may also include one or more means for sharing and/or obtaining data from electronic devices, such as another terminal, a server 22, an AP 30, a client 32 or the like, in accordance with any of a number of different wireline and/or wireless techniques. For example, the terminal may include a RF transceiver 64 and/or an IrDA transceiver 66 such that the terminal may share and/or obtain data in accordance with radio frequency (e.g., WLAN) and/or infrared techniques. Also, for example, the terminal may include a Bluetooth (BT) transceiver 68 such that the terminal may share and/or obtain data in accordance with Bluetooth transfer techniques.

The terminal may further include memory, such as a subscriber identity module (SIM) 70, a removable user identity module (R-UIM) or the like, which typically stores information elements related to a mobile subscriber. In addition to the SIM, the terminal may include other memory, such as volatile memory 72, and/or other non-volatile memory 74 (embedded and/or may be removable non-volatile memory). For example, the other non-volatile memory may comprise embedded or removable multimedia memory cards (MMCs), Memory Sticks manufactured by Sony Corporation, EEPROM, flash memory, hard disk or the like.

The memories 70, 72, 74 may store any of a number of pieces of information, and data, used by the terminal to implement the functions of the terminal. For example, the memories may store an identifier, such as an international mobile equipment identification (IMEI) code, uniquely identifying the terminal, such as to the MSC 16. The memories may also store one or more widgets for providing content such as headline news, exchange rates, sports results, stock quotes, weather forecasts, multilingual phrase dictionaries, encyclopedias, maps, entertainment listings, personal online calendars, or the like to a user. And again, for example, one or more widgets may provide messaging-related content for one or more messaging applications, and may interface with one or more of these applications for provision of one or more messaging functions to the user.

In one or more configurations, a user of a terminal 10 may input desired data into the terminal, organize the data within the terminal, or display the information in a convenient manner. For example, a system for providing desired information in a terminal may include a system API (application program interface) through which a third-party widget source (e.g., server 22) may provide content to the terminal. In addition, the system may include a widget API for providing a standardized interface for communication with a user interface element including or otherwise displaying desired content. One such user interface element is commonly referred to as a “widget.” In this regard, a widget may be considered a downloadable, interactive virtual tool (software tool) that provides content such as headline news, exchange rates, sports results, stock quotes, weather forecasts, multilingual phrase dictionaries, encyclopedias, maps, entertainment listings, personal online calendars, messaging-related content, or the like to a user. A widget may be configured to continuously receive content, such as continuously updated content, from the widget source and/or one or more other sources, when the terminal or widget is operated in an on-line mode. This content may be formatted, for example, as a web feed such as in accordance with the RSS (Really Simple Syndication) format, Atom format or the like.

The system API may, for example, communicate with the widget via the widget API. Also, the widget may access information from third-party sources via the widget API. The widget may include one or more applications linked to one or more sources for accessing, sending and/or retrieving information from those sources without relying on a separate application. More particularly, for example, the widget may include one or more web applications linked to one or more web servers (e.g., servers) for accessing, sending and/or retrieving information from those web servers without relying on a separate web browser.

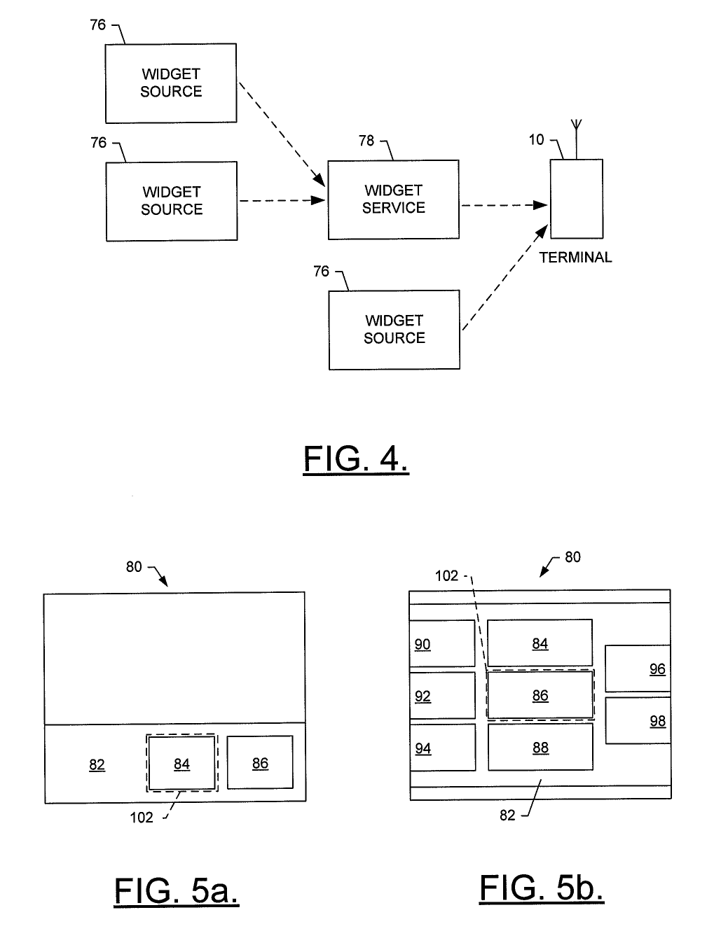

Widgets may be acquired in a variety of ways including through e-mail and/or by download from one or more sources, such as one or more servers 22 (as well as one or more digital broadcasters of digital broadcast networks—not shown). As shown in the functional block diagram of FIG. 4, one or more widget sources 76 (e.g., server 22) may provide respective one or more widgets to a terminal 10. Additionally or alternatively, however, a particular source may offer to a terminal a service (shown as widget service 78) whereby the widget service collects widgets from one or more other widget sources, and provides the collected widgets to the terminal. And in further exemplary embodiments, whether the widget sources provide widgets to a terminal themselves or through a widget service, the widget service may monitor the content provided by the widgets and notify the terminal of changes in that content. The terminal may therefore download or otherwise obtain the changed content for display to the user. In this regard, either or both of the source or service may implement a mobile server gateway for creating and maintaining mobile connections between a terminal and the respective source or service.

Widgets may be arranged and displayed on a dashboard located in a particular area of the display of a terminal 10. Although reference may be made to arranging and displaying widgets, it should be understood that the arrangement and/or display of a widget may more particularly refer to content of the widget. In this regard, the content of a widget may include at various instances a representation (e.g., icon or other indicia) of the widget, and/or multimedia content presented by the widget. As explained herein, terms such as “present,” “display” or the like may be used interchangeably. Further, such terms may not only refer to the actual presentation, display or the like of content and information by a display, but may separately refer to appropriate software (e.g., widget API) directing presentation, display or the like of the content and information by the display.

A dashboard may refer to a predefined area of the display in which one or more widgets may be placed and organized. The dashboard provides delivery of messages from the widget API to the service or web server. The dashboard may further include a dashboard API for providing access to terminal resources and for presenting a user interface corresponding to a widget. The dashboard API may contain at least two parts. One part may be an API for the development of widgets such as design, placement on a display, content, etc. Another part of the dashboard API may be provided for third-party developers. In another example, the dashboard API may be built over a terminal operating system or over any other API available on the terminal. In another example, the system may also include a mobile server gateway for creating and maintaining mobile connections between a terminal and a service.

As shown in FIGS. 5a and 5b, for example, the display 80 (e.g., display 44, 58) of a terminal 10 may present a dashboard 82 on which one or more widgets may be situated or otherwise positioned (widgets 84 and 86 being shown in the embodiment of FIG. 5a; and widgets 84-98 being shown in the embodiment of FIG. 5b). In this regard, the dashboard may be defined by a fixed area of the display dedicated to presenting one or more types of information such as widgets. The area occupied by dashboard may be set by the user or predefined by a system default. The dashboard may also be a flexible area that expands or contracts depending on the amount of information to be displayed. In instances where the dashboard has a fixed size, widgets from various sources may compete for space on a particular user's dashboard. In some cases, one spot, for example, the middle of dashboard, may be more desirable than a left or right position.

The dashboard 82 may also include a frame 102 for selecting and opening a widget 84-98 on the dashboard. The frame may be movable with respect to the widgets, or alternatively the widgets may be movable with respect to the frame, to align the frame with a particular widget to thereby select the widget for opening. When aligned with a particular widget, the frame may be displayed and/or applied as a border to the widget. The frame may further be colored to stand out from the coloring of the widgets. Additionally or alternatively, the frame's shape and size may be automatically modified to suit the shape and size of the widget with which the frame is aligned. The dashboard may further be configured so that the frame may be movable to an area of the dashboard not having any widgets to thereby show that no widgets are currently being selected.

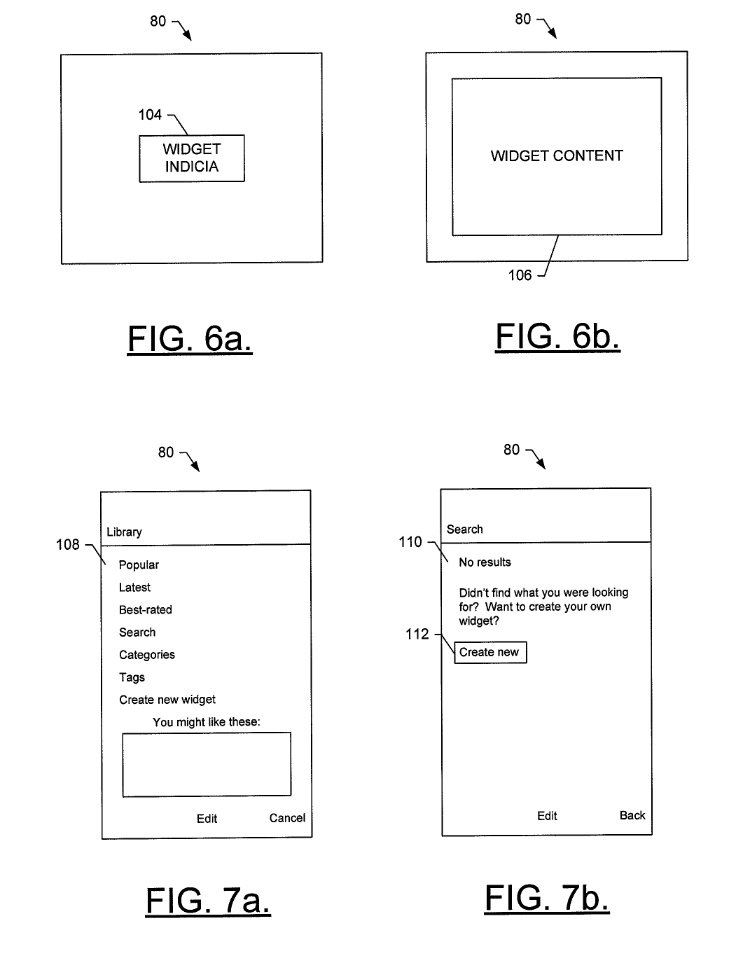

On a dashboard 82, the widgets 84, 86 may be represented by icons or other indicia 104 identifying the respective widgets. A user may then open a widget from the dashboard to direct the terminal to present the widget's content on the display 80. The opened widget may be presented in a number of different manners, such as in a remaining portion of the display (portion other than that occupied by the dashboard) or in a portion or all of the display without the dashboard, and thus the other widgets, also being presented by the display. As shown in FIG. 6a, the widget may be presented in a minimized view whereby the opened widget's icon or other indicia is presented by the display without the dashboard, and thus, the other widgets. Alternatively, as shown in FIG. 6b, the widget may be presented in a maximized view whereby the widget and its content 106 are presented by the display, again without the dashboard. In addition to or in lieu of presenting the opened widget's icon or other indicia, the minimized view of the widget may include one or more items of content from the widget, such as by presenting one or more weather items (e.g., weather report summary) in the context of a widget generally providing weather forecasts, presenting one or more selected stock quotes in the context of a widget generally providing stock quotes, or the like. And although the widget may be presented in a minimized or maximized view, the display may be configured to selectively display the widget in its minimized or maximized views, such as in a manner as desired by the user.

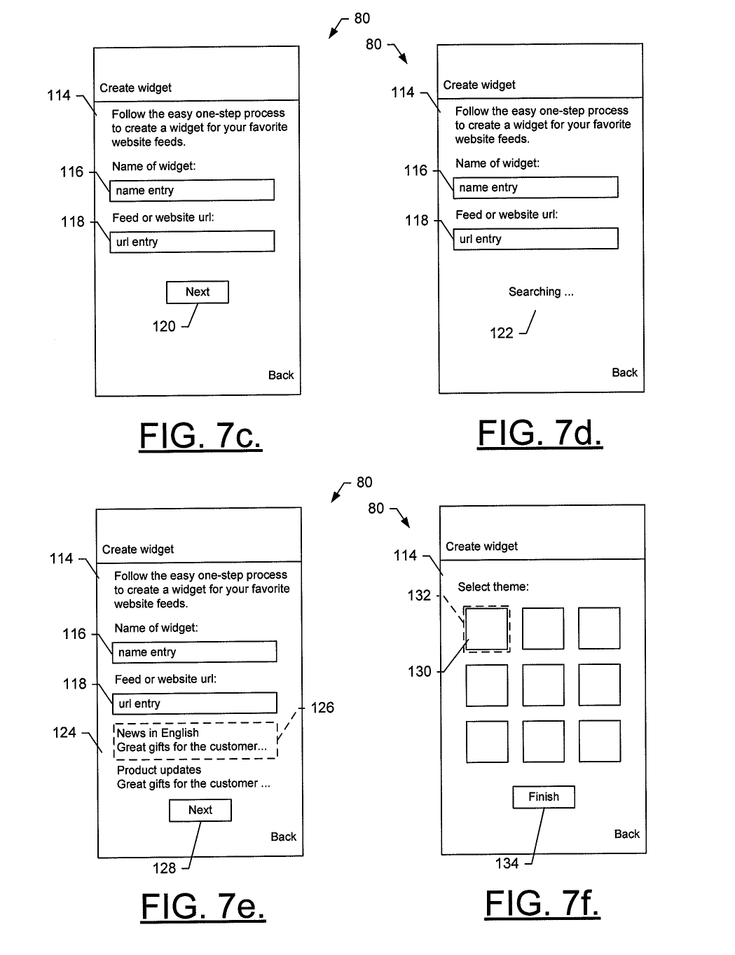

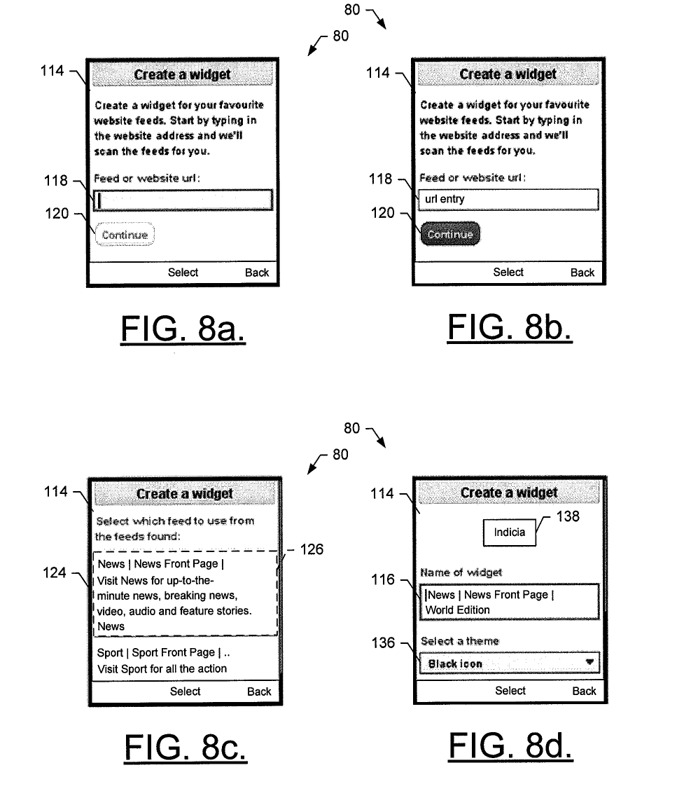

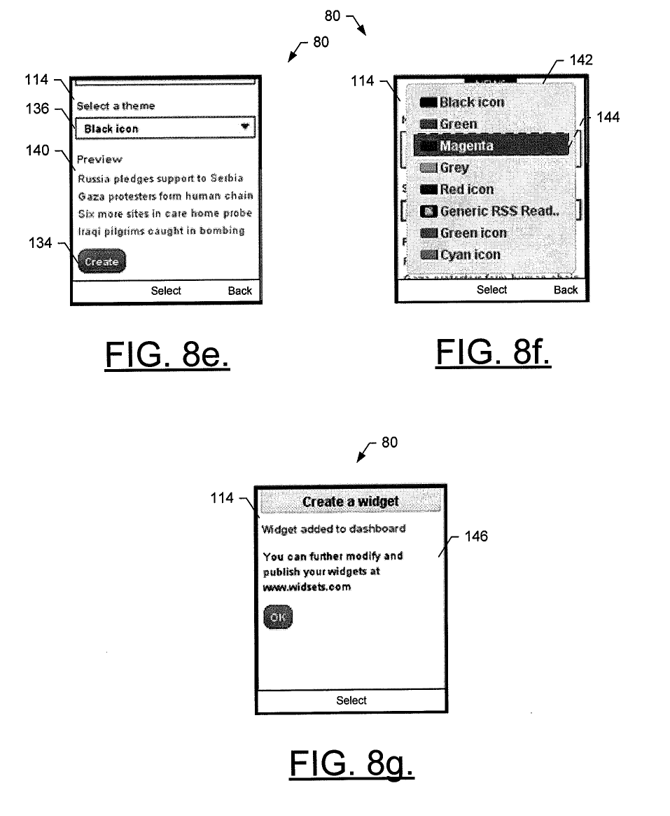

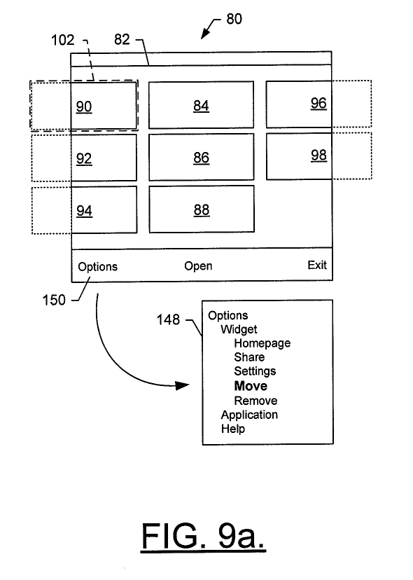

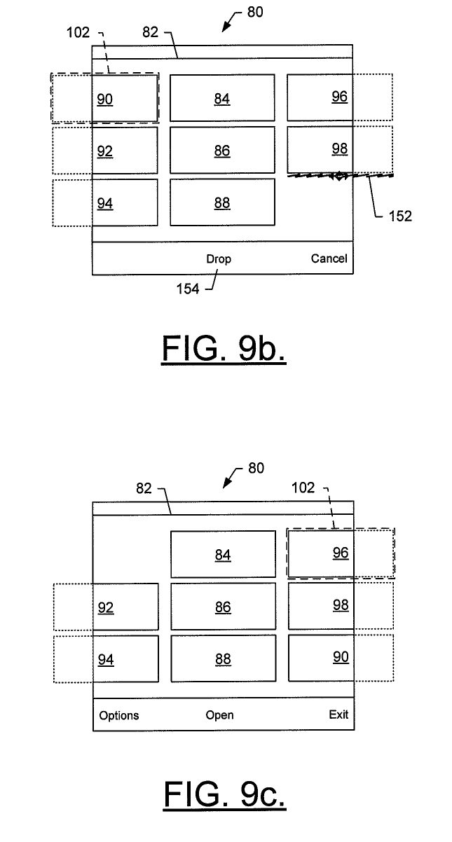

As indicated above, the dashboard 82 may include a dashboard API, which may include an API for the development of widgets such as design, placement on the display 80, content, or the like. At any given instance, then, one or more widgets presented on the dashboard may be modified, including being added to or removed from the dashboard, as well as being moved around or otherwise repositioned within the area of the dashboard. In this regard, FIGS. 7a-7f and 8a-8g graphically illustrate by way of presentations of the display a method for adding a new widget to the dashboard according to two exemplary embodiments of the present invention; and FIGS. 9a-9c graphically illustrate by way of presentations of the display a method for repositioning a widget within the area of the dashboard according to an exemplary embodiment of the present invention. As shown in FIG. 7a, a widget may be added to the dashboard from a library 108 that lists or otherwise indicates available widgets, where the list may be locally stored by the terminal and/or downloaded or compiled from one or more widget sources 76 and/or services 78. As also shown, the available widgets listed in the library may be categorized or otherwise organized in one or more categories from which particular widgets may be identified, and may be searchable. Once identified in the library, then, a desired widget may be downloaded to, and installed for use on, the terminal, such as by adding the advertised widget to the dashboard.

In various instances, the user may desire to acquire a non-existent or otherwise unavailable widget; and in such instances, the dashboard API may permit the user to create or otherwise set up a new widget. In this regard, the user may select or otherwise indicate a desire to create a new widget from the library 108, and/or from an unsuccessful search for an available widget (see, e.g., search screen 110 and “create new” control 112 of FIG. 7b). On receipt of the user's selection to create a new widget, then, the dashboard API may direct presentation of a number of screens 114 configured to lead the user through the process of creating a new widget, as shown in FIGS. 7c-7f.

As shown in FIG. 7c, the screens 114 from which the user may direct creation of a new widget may include a screen including text entry fields 116 and 118 from which a user may enter or otherwise select (and the terminal 10, or rather dashboard API, may receive) a name and network address (e.g., uniform resource locator—URL) of content for the new widget (where the address may more particularly point to a path on the source where the content may be fed from a respective source 76). Once the name and network address have been received into the respective fields, the user may proceed to the next step in the process, such as by actuating a control 120 on the screen. In response, the dashboard API may perform a search for content at the respective, entered network address, and may further search for content formatted in a manner acceptable for a widget (e.g., web feed) (see, e.g., FIG. 7d providing the user with an indication 122 of this search).

After performing the search for content, the dashboard API may present a screen 114 including one or more indications 124 of content available at the entered network address, and for which a widget may be created, as shown for example in FIG. 7e (illustrating two available web feeds at the entered network address). The dashboard API may then direct presentation of a moveable frame 126 that the user may control into alignment with desired content (e.g., web feed), such as in a manner similar to that in which the frame 102 of the dashboard 82 may be aligned with a particular widget on the dashboard. Once in alignment with desired content, the user may proceed, such as in a manner similar to before by actuating a control 128 on the screen. As shown in FIG. 7f, the dashboard API may then direct presentation of one or more icons or other indicia 130 selectable for representing the new widget. In various instances, one or more of these indicia may form “themes” each including one or more indicia, and including one or more other parameters such as, for example, parameters directing the manner of presentation of the indicia and/or new widget once selected (e.g., in the minimized and/or maximized views). Similar to before, then, a movable frame 132 may be presented and whose movement may be controlled by the user into alignment with a desired indicia to thereby select the respective indicia. Once a desired indicia or theme has been selected the user may finish the process, such as by actuating a control 134.

More particularly, for example, the aforementioned themes may comprise template widgets or “empty widget shells” for a reader widget that may be configured to display content when it is taken into use or otherwise selected. The template may include an icon (e.g., web icon) or other indicia for presenting the new widget, and may include certain color scheme and/or graphical style (e.g., images, margins, backgrounds, padding, selector style etc.). In this regard, a number of, if not all, reader widgets (including template widgets) configured to display similarly-formatted content (e.g., RSS web feed content) may share the same or similar logic (e.g., script code) for downloading and presenting the content, and/or for interacting with a user; but these widgets may differ in their indicia and/or color scheme, which may be selectable as a theme for the new widget.

It should be understood that the aforementioned manner of creating a new widget may be modified in any of a number of different manners, which may or may not result in different presentations of the display 80. In this regard, FIGS. 8a-8g graphically illustrate by way of presentations of the display another exemplary method for adding a new widget to the dashboard. As shown in FIGS. 8a and 8b, the screens 114 from which the user may direct creation of a new widget according to this exemplary embodiment may include a screen including a text entry field 118 from which a user may enter or otherwise select (and the terminal 10, or rather dashboard API, may receive) the network address (e.g., uniform resource locator—URL) of content for the new widget (where the address may more particularly point to a path on the source where the content may be fed from a respective source 76). Once the network address has been received into the respective field, the user may proceed to the next step in the process, such as by actuating a control 120 on the screen (the control in this example being activated for actuation in response to entry of the network address). In response, the dashboard API may perform a search for content at the respective, entered network address, and may further search for content formatted in a manner acceptable for a widget.

After performing the search for content, the dashboard API may present a screen 114 including one or more indications 124 of content available at the entered network address, and for which a widget may be created, as shown for example in FIG. 8c (illustrating two available web feeds at the entered network address). The dashboard API may then direct presentation of a moveable frame 126 that the user may control into alignment with desired content (e.g., web feed), such as in a manner similar to that in which the frame 102 of the dashboard 82 may be aligned with a particular widget on the dashboard. Once in alignment with desired content, the user may proceed, such as by actuating a control (not shown). As shown in FIG. 8d, the dashboard API may then present a default name and indicia 138 for the new widget, which may be defined or otherwise acquired based on the selected, desired content. The name (and if so desired indicia) may be modifiable by the user, and accordingly, as shown, the default name may be presented within an editable text entry field 116.

As also shown in FIG. 8d, and continuing to FIG. 8e (FIGS. 8d and 8e being separate screens or the same screen that may be scrollable within the display 80), the dashboard API may permit selection of a “theme” for the new widget, and may have a pre-selected default theme and a preview 140 of that (or any other, later-selected frame. The theme, then, may be selected in a number of different manners, such as from a drop-down menu 136 of available themes, actuation of which may direct presentation of an overlay window 142 including a number of available themes one of which may be selected via an appropriate frame 144, as shown in FIG. 8f. Once a desired theme has been selected the user may finish the process, such as by actuating a control 134, following which the dashboard API may present a confirmation 146 of the widget's creation, as shown in FIG. 8g.

Regardless of the exact manner by which a widget is created, once created, the dashboard API may generate the new widget including the entered name and receive the selected content at the entered network address, and may add the new widget to the dashboard 82 of the display 80. In addition, the dashboard API may communicate the new widget to a widget source 76 and/or service 78, which if so desired, may publish the widget for download and installation by other terminals 10, such as in a library of available widgets.

Turning to FIG. 9a, the user may direct performance of one or more functions with respect to widgets on the dashboard 82, such as via an options menu 148 that may be activated upon actuation of an appropriate soft key 150 (portions of widgets on the dashboard that may not be displayed at a particular instance—but may be otherwise displayable by scrolling the display—being shown for purposes of illustration only). As shown in the exemplary options menu (the menu being shown outside the display 80 for illustration only), these functions may include, for example, directing presentation of the homepage of a widget source 76 or service 78 (“homepage”), sharing a widget (“share”), changing the settings for one or more widgets on the dashboard (“settings”), as well as moving (“move”) or removing (“remove”) one or more widgets within or from the dashboard.

Should the user desire to move a widget from one position to another on the dashboard 82, the user may select a widget on the dashboard 82 (e.g., by aligning frame 102 with the appropriate widget—shown for example as widget 90), and select the appropriate option from the options menu (“move”). In response, the dashboard API may direct presentation of a placement indicator 152 indicating an available placement of the selected widget relative to other widgets on the display. This placement indicator may be initially positioned at a default position on the dashboard (e.g., at the current position of the selected widget), but may be movable by the user, such as via directional keys (↑, →, ↓, ←) on a keypad of the terminal 10. The user may therefore direct movement of the placement indicator to a desired position on the display for placement of the selected widget, following which the user may direct placement of the selected widget at the selected position, such as by actuating an appropriate soft key 154 (e.g., “drop”), shown in FIG. 9c (compare placement of widget 90 from, e.g., FIG. 9a). Although not necessarily shown in FIG. 9c, movement of the selected widget from one position to another on the dashboard may at times result in repositioning and/or resizing of one or more other widgets on the dashboard, such as to fit the selected widget.

In various instances, a widget (first widget) may be associated with one or more other widgets (second widget). During presentation of the widget, then, the associated widget(s) may be advertised to the user to thereby encourage the user to select one or more of those widget(s). The selected widget(s) (second widget) may then be downloaded and/or presented for display by the user's terminal 10, such as in a manner similar to that of the widget (first widget) associated therewith. Although the content of the associated widgets may be uncorrelated to that of the widget with which they are associated, the content may alternatively be related to that of the respective widget. For example, a widget presenting a television programming guide may be associated with another widget configured to present content related to a movie theater (both being correlated by their relationship to entertainment options available to the user). For more information on such a feature, see U.S. patent application Ser. No. 11/753,786, entitled: Network Entity, Terminal, Computer-Readable Storage Medium and Method for Providing Widgets Including Advertisements for Associated Widgets, filed May 25, 2007, the content of which is hereby incorporated by reference in its entirety.

Generally, the display 80 (e.g., display 44, 58) may be configured to present content in a series of screens, one or more of which may be presented when the terminal is in a particular operational state. The terminal may be configured to present a standby screen when the terminal is in a standby state, which may be the “root” of a hierarchical menu system. This state may be entered when the terminal is switched on, or when the terminal is active but is not being used for a specific application (becomes idle—in an idle state). In accordance with exemplary embodiments of the present invention, the widget API may be configured to present, to the user, advertisements for one or more other widgets while the terminal 10 is in a standby operational state, and thus presenting a standby screen. During presentation of the standby screen, then, the widget API may direct presentation of the widget advertisement(s) to thereby encourage the user to select one or more of the respective widget(s). Similar to before, the selected widget(s) may then be downloaded and/or presented for display by the user's terminal 10, such as in the standby screen in a manner similar to that of the advertisement.

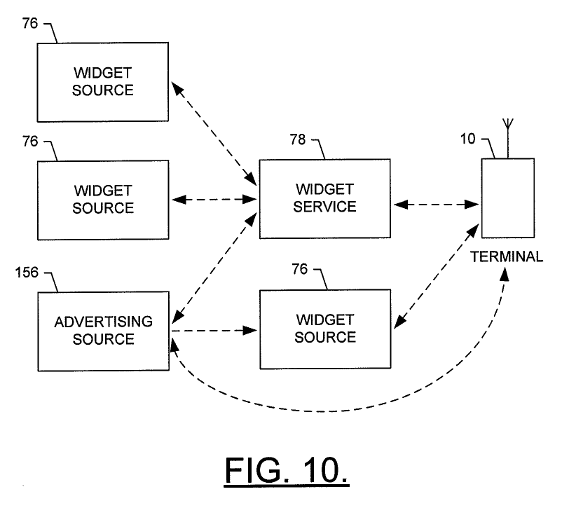

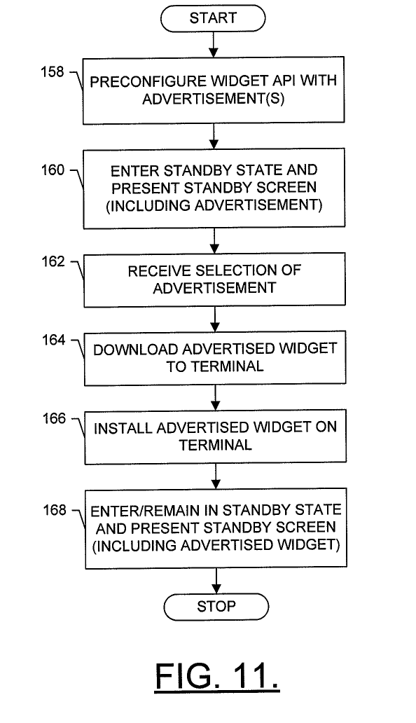

Reference is now made to FIGS. 10 and 11, which illustrate a functional block diagram and flowchart of a system and method according to exemplary embodiments of the present invention. As shown in block 158, the widget API may be preconfigured with one or more advertisements for subsequent receipt and presentation on the standby screen. Although the widget API may include one or more advertisements, it should be understood that in various instances the widget API may be additionally or alternatively preconfigured with one or more advertisement placeholders, or other references or links, to one or more advertisements for subsequent receipt and presentation on the standby screen. In such instances, the placeholder(s)/reference(s) may be associated with predetermined advertisement(s), or may be associated with later-determined advertisement(s).

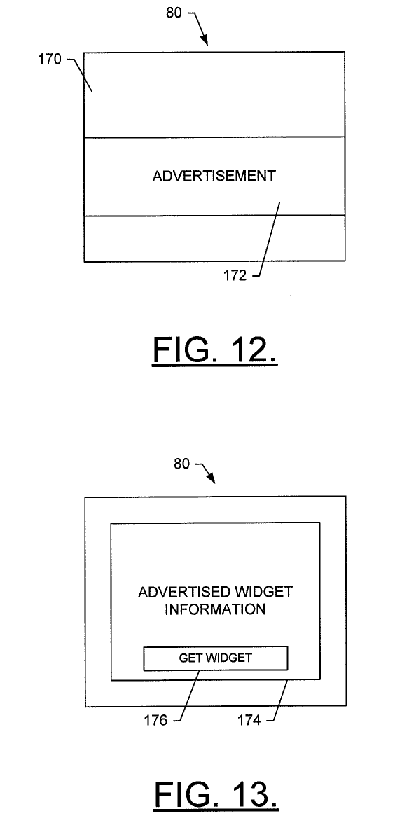

Sometime after the terminal 10 is preconfigured with or otherwise receives the advertisement(s), the terminal may enter into the standby state during which the terminal's display 80 is configured to present a standby screen, as shown in block 160. As indicated above, the standby state may be entered into in any of a number of different manners, such as when the terminal is switched on, or when the terminal is active but becomes idle. On the standby screen, the widget API may be configured to present one or more of the preconfigured advertisement(s), where if the advertisement(s) are preconfigured, the terminal need not conduct any network communication to enable presentation of the advertisement(s). As shown in FIG. 12, the standby screen 170 may include an advertisement 172, where the advertisement may be positioned within its own “zone” or area of the standby screen. Similar to the dashboard, the area occupied by the advertisement(s) may be a fixed area, or a flexible area that expands or contracts depending on the amount of information to be displayed; and may be dedicated to presenting widget advertisements and/or widget content. In addition to the advertisement, the standby screen may include one or more other elements in respective zones or areas. These other elements may include, for example, one or more other widgets or control items that cause the terminal to enter a new state (e.g., shortcut to an application, etc.), one or more information items that convey information to the user (e.g., clock, signal strength, power level, alarm clock, number of unread messages, calendar information, user note, etc.), or the like.

If an advertisement is not otherwise preconfigured with the widget API but is instead associated with a placeholder/reference, the respective advertisement 172 may be received by the terminal from one or more advertising source(s) 156 (e.g., server 22, digital broadcaster, etc.), directly or via a widget source 76 or service 78 configured to provide content to the widget API, as shown in FIG. 10. These advertising source(s) may function as widget sources for respective one or more widgets, but may also be configured to supply advertisements for those respective widget(s). In this regard, although, the widget sources, widget services and advertising sources may be separate network entities, in some embodiments, one or more entities may support one or more of a widget source, service or advertising source, logically separated but co-located within the entit(ies). For example, a single entity may support a logically separate, but co-located, widget source and widget service. Also, for example, a single entity may support a logically separate, but co-located widget service and advertising source. And further, for example, a single entity may support a logically separate, but co-located widget source, widget service and advertising source.

In instances in which an advertisement is associated with a placeholder/reference, for example, the widget API on the terminal 10 may be configured to send, to a source 76 or service 78, a request for an advertisement 172 for another widget associated therewith. This request may include, for example, an address (e.g., IP address) of the respective source or service, the identifier of the respective other widget, and an identifier of the terminal (or user of the terminal). Before sending the request, however, the widget may (but need not) be configured to request and receive the terminal user's acceptance of advertisements, such as via the terminal's user interface. The respective source or service may then determine whether the respective terminal/terminal user may receive advertisements (for, e.g., subscription services). If the terminal/terminal user may receive advertisements, the source or service may determine the appropriate advertisement, and return it to the terminal.

Also in instances in which an advertisement is associated with a placeholder/reference, the advertisement 172 may be sent the terminal 10 in any of a number of different manners. In accordance with a pull technique, for example, the widget API may be configured or otherwise triggered to request one or more advertisements at one or more instances in response to presentation of the standby screen 170, passage of a given time period during presentation of the standby screen, or the like. In accordance with a push technique, for example, the source(s) 76 and/or service(s) 78 may be configured to push the advertisements to the terminal at one or more instances in response to receiving an indication from the terminal related to presentation of the standby screen (e.g., indication related to one or more of the triggering events explained above with respect to the pull technique). And in further exemplary embodiments, the advertisements may be sent the terminal in accordance with a combination of push and pull techniques.

Regardless of whether the advertisement(s) are preconfigured or acquired by the terminal 10, the widget API may be configured to present the advertisement(s) on the standby screen 170 when the terminal is in the standby state, again, as shown in block 160. For example, the widget API may be configured to present one or more advertisements during each instance of the terminal in the standby state, where the respective advertisement(s) may be the same or differ from one instance to the next. Further, for example, during one or more instances of the terminal in the standby state, the widget API may be configured to selectively present an advertisement from a plurality of advertisements such as by periodically scrolling through the advertisements.

If the user is interested in the advertised widget, the user may select and the terminal may receive selection of the advertisement, as shown in block 162. In this regard, the advertisement may comprise or include a selectable link or control to enable the user to select the advertisement. In response, the widget API may initiate the terminal downloading or otherwise receiving the advertised widget by the terminal, as shown in block 164. Before, downloading or otherwise receiving the advertised widget, however, it may be desirable for the user to receive further information as to the advertised widget so that the user may more effectively assess the user's interest in the widget. Thus, in one exemplary embodiment, in response to receiving selection of the advertisement, the widget may send a request for additional information as to the advertised widget. In this regard, the request may be sent to, and received by, the widget source 76 or service 78 from which the terminal received the respective widget, or the advertising source 156 originating the advertisement and the advertised widget.

In response to the request, the widget source 76, service 78 or advertising source 156 may send, to the terminal 10, the requested additional information related to the advertised widget. This information may be sent to, and received by, the terminal in any of a number of different manners and forms. For example, the information may be received as content configured for presentation by the widget API, or as a separate widget configured for operation by the terminal in a manner similar to other widgets. Regardless of the manner and form of receiving the additional information, the terminal may thereafter present the additional information 174 in the display 80, as shown in FIG. 13.

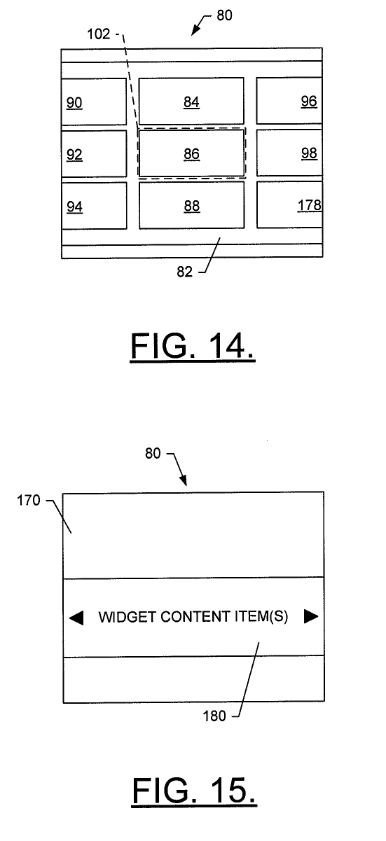

As or after the terminal 10 presents the additional information 174, again if the user is interested in the advertised widget, the user may select and the terminal may receive selection of the advertised widget to thereby direct the terminal to download the advertised widget, such as via a control 176 presented along with the additional information. In response, the widget API (or separate widget) may initiate the terminal downloading or otherwise receiving the advertised widget. For example, the advertised widget may be downloaded from a widget service 78 or the advertising source 156 originating the advertisement and the advertised widget. In this regard, the service or advertising source may receive a request for the advertised widget, to which the respective network entity may respond by sending the requested, advertised widget to the terminal. Then, on receipt of the advertised widget, the terminal may install the widget for use on the terminal, such as by opening the advertised widget (in a minimized or maximized view) and/or adding the respective widget to the dashboard 82 of the display 80, shown in block 166 of FIG. 11 and as added widget 178 in FIG. 14 (compare, e.g., FIG. 5b).

In addition to or in lieu of adding the advertised widget to the dashboard 82, the advertised widget may be added to the area occupied by the advertisement(s) on the standby screen 170, or may otherwise replace the advertisement(s) in the respective area, while the terminal 10 is in the standby mode, as shown in block 168 and FIG. 15, for example. In such instances, the advertised widget may be presented in a minimized or maximized view in the respective area. In one particular embodiment, for example, the advertised widget may be presented in the respective area of the standby screen in a minimized view including one or more items of content 180 from the widget. And in instances in which the advertised widget is added to the area occupied by the advertisement(s) (instead of replacing the advertisement(s)), the advertised widget and advertisement(s) may be presented such that one or the other of the widget or advertisement(s) may be selectively presented at any given time. The area may then be scrollable (left and right scroll arrows being shown in FIG. 15, although other scroll directions may be employed) to selectively present the advertised widget or advertisement(s). Also in such instances, given that the advertised widget has been downloaded and installed for use on the terminal, the widget API may be configured to present one or more advertisements for one or more widgets other than the advertised widget, such as in a manner similar to before.

As explained above, widgets may be advertised from other, associated widgets on the dashboard 82 of the display, and/or on the standby screen 170 of the display. It should be understood, then, that the widget API may be configured to present advertisement(s) in the dashboard. Additionally or alternatively, one or more widgets presented in the dashboard may be added to or otherwise presented on the standby screen (in addition to or in place of one or more other widgets on the standby screen). In such instances, if a limited number of widgets (e.g., one) are viewable at any given time, the area occupied by the widgets may be scrollable to selectively view the respective widgets on the standby screen (including, if so desired, one or more advertisement(s)).

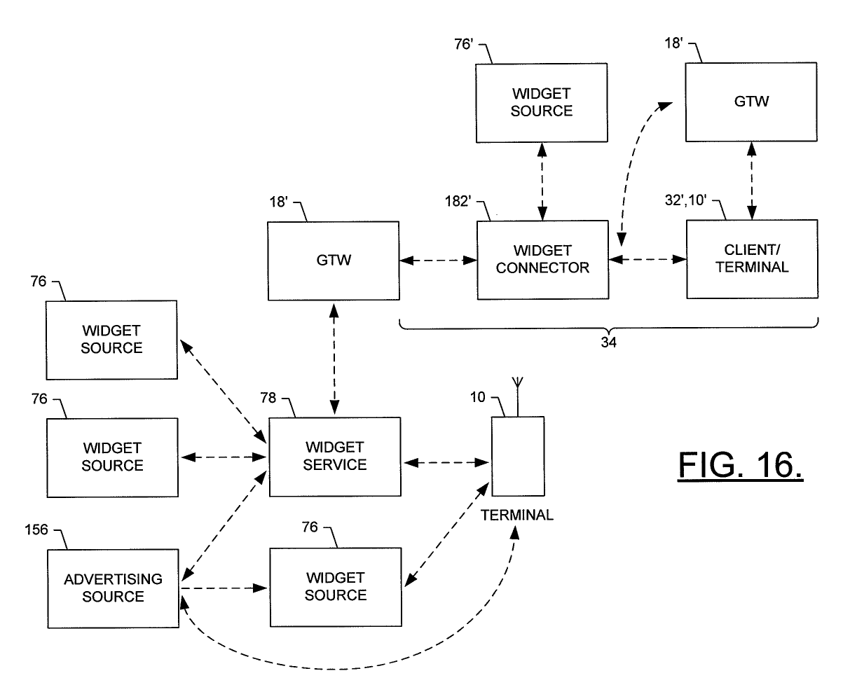

In various instances, one or more widgets may include components or, as more particularly explained below, provide content from a widget source 76′ within an Intranet 34 (referred to herein as “Intranet content”). Reference is now made to FIGS. 16, 17 and 18, which illustrate a functional block diagram and flowcharts of a system and methods according to further exemplary embodiments of the present invention. As shown in FIG. 16, to effectuate this feature, the Intranet may include a widget connector 182′ (e.g., server 22′) configured to manage the secure setting up of widgets configured to provide Intranet content, as well as the provision of Intranet content to those widgets once installed on a terminal 10. In this regard, the widget connector may have a pre-established trust relationship with an appropriate widget service 78 outside the Intranet, such as by symmetric-key cryptography. As shown and explained herein, the widget and its Intranet content may be provided to a terminal outside the Intranet by an appropriate widget service 78, although it should be understood that the content may be equally provided by a widget source 76 (directly or via a widget service).

In accordance with one exemplary embodiment, the widget connector 182′ may be configured to generate or otherwise make available a selectable control, link or the like (hereinafter generally referred to as a “link”), which may be presentable by a client 32′, terminal 10′ or the like within the Intranet 34. For example, the link may comprise a hypertext transfer protocol (HTTP) link on a web page presentable by a web browser operable by the client/terminal. This link, then, may be selectable for initiating a transaction for creating or otherwise setting up a widget, including setting parameters for a widget, that once installed may receive content from a restricted Intranet (Intranet content). These parameters may be associated with the link and include, for example, a network address (e.g., URL) of Intranet content (e.g., web feed) from a widget source 76′, an identifier (ID) or name for a widget, or the like. The link (and its parameters) may be generated without regard to user (or user's client/terminal) that may ultimately select the link and/or without regard to a number of selections of the link. In one exemplary embodiment, however, the link (and its parameters) may be dynamically generated for a particular user and/or a particular number of selections (e.g., one), such as for security purposes to reduce the likelihood of unauthorized receipt of the Intranet content.

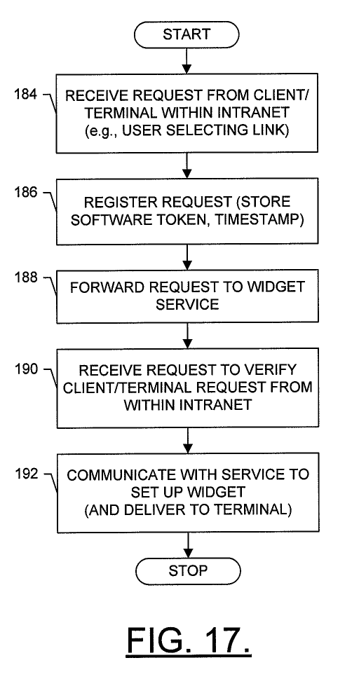

As shown in block 184 of FIG. 17, then, a method according to one exemplary embodiment may include the widget connector 182′ receiving a request from a client 32′, terminal 10′ (mobile client) or the like. The widget connector may receive the request in a number of different manners including, for example, in response to a user of the client/terminal logging into the Intranet (e.g., from an appropriate GTW 18′), retrieving a web page (from within the Intranet) including the aforementioned link, and selecting the link. In response to receiving the request, the widget connector may register the request (at times referred to by the action taken by the user to initiate the request, e.g., “click”), as shown in block 186. In this regard, registering the request may include the widget connector storing the request along with, for example, a timestamp as to when the connector received the request (or the user selected the link) and an appropriate software token that may be associated with the user and may be later used to verify the request and in a token-based authentication scheme to authenticate a widget of the user to receive respective Intranet content.

Also in response to receiving the request, the widget connector 182′ may forward the request to an appropriate widget service 78 (before, after or as the connector registers the request), such as in a manner permitting the service to respond to the requesting client 32′/terminal 10′ (directly or via the widget connector), as shown in block 188. As appropriate and in response to the request, the widget service may authenticate the respective user to the service (e.g., manually by username/password, automatically by an established web session/cookie, etc.). The service may then verify with the widget connector (and the connector receive a request for verification) that the request originated from within an appropriate Intranet 34, as shown in block 190. This verification may be accomplished in any of a number of different manners, but in one exemplary embodiment, may be accomplished by verifying that the widget connector registered the request from the requesting client/terminal, and that the registered request includes the appropriate software token. Once the request has been verified, the widget connector may forward the software token to the service, and communicate with the widget service to create or otherwise set up the respective widget with the service, as shown in block 192. The widget may be created/set up in a number of different manners, and may include the widget connector 182′ forwarding, in addition to the software token, the parameters associated with the link to the widget service 78. Again, these parameters may include the network address (e.g., URL) of Intranet content (e.g., web feed) of the Intranet source 76′, widget ID or name, or the like. The widget may then be created or otherwise set up by the widget service based upon or to otherwise include these parameters, which may include storing (in a database) the parameters for the widget along with an indication of the Intranet within which the respective widget source is located. The created/set up widget may then be delivered to the appropriate terminal 10 (the terminal may be identified as being associated with the user authenticated to the service) for installation and use thereat, such as to receive Intranet content from the Intranet widget source 76′ via the service 78. In addition, the service may be added to a library of available widgets, but otherwise remain invisible to outside terminals 10 accessing that library.

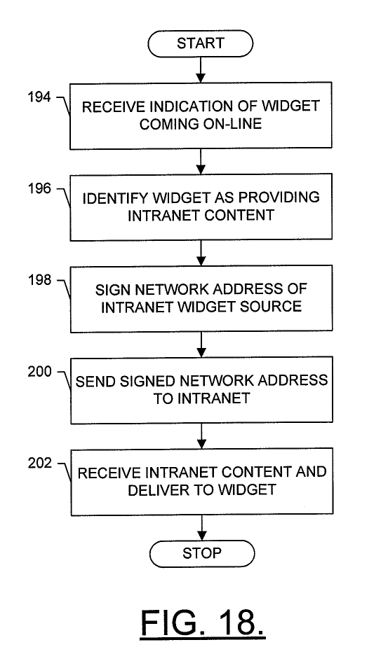

Once a terminal 10 has installed the widget delivered by the service, the widget may be configured to receive (e.g., continuously receive) Intranet content from the Intranet widget source 76′, when the terminal or widget is operated in an on-line mode. In this regard, the widget service 78 may receive an indication of the widget coming on-line, and in response thereto, may implement a fetcher function to request the respective Intranet content from the Intranet source, as shown in block 194 of FIG. 18. In this regard, the service (or fetcher) may identify the widget as providing content from a source within an Intranet 34, or as otherwise being bound to a token authentication scheme with an Intranet, as shown in block 196. The service may then communicate with the widget connector (an entity of the Intranet) to authenticate the widget to receive respective Intranet content, such as in accordance with a token-based authentication scheme.

To authenticate the widget, the service 78 may retrieve the software token and network address of content provided by the widget (from the database within which the token was stored with the other widget parameters during setting up of the widget). The service may then formulate a call or request for content from the respective network address, and sign the request with the token, as shown in block 198. In addition, the service may sign the request with one or more of a cryptographic key (e.g., symmetric key) of a cryptographic scheme (e.g., symmetric-key cryptography) implemented between the service and widget connector 182′ of the respective Intranet, or one or more parameters otherwise included in the request such as a timestamp, identifier of the user who's widget is requesting the content (e.g., username), or the like. The request may be signed in a number of different manners, including for example, by concatenating and then hashing the aforementioned parameters as applicable (e.g., token, cryptographic key, parameter(s) of the request, etc.), and adding the hashed parameters to the request as a signature.

After signing the network address of the Intranet content of the Intranet widget source 76′, the service 78 (or fetcher) may send the signed request for the Intranet content to the widget connector 182′ of the appropriate Intranet 34, as shown in block 200. On receipt of the signed request, then, the widget connector may verify the signature to thereby authenticate the widget, such as by generating a signature in a manner similar to that explained above and comparing it to the signature accompanying the request to identify a match. In this regard, the connector may have prior knowledge of some of the parameters of the signature (e.g., token, shared cryptographic key, etc.), and may obtain the other parameters from the request (e.g., user identifier, timestamp, etc.). If verified, the widget connector may retrieve the appropriate Intranet content from the source and forward that content to the service.

As shown in block 202, the service 78 may receive the Intranet content (from the source 76′ via the widget connector 182′) and deliver it to the widget installed on the terminal 10. The widget connector may maintain or otherwise interpret the request to continuously retrieve and forward the Intranet content to the service, which may continuously deliver the Intranet content to the terminal. As an added security measure, however, the widget connector may be configured to only maintain a particular request (and thus retrieve and forward Intranet content) for a particular period of time, which may be judged based on a current time and the time reflected by the timestamp also by which the service signed the network address, after which the widget connector may require a new request from the service, or altogether require the widget to be re-setup. Additionally, by maintaining the request for a period of time, the widget connector may recognize a second request for the same Intranet content utilizing the same software token, and if that token is only authorized for use by one user, may discard the second request.

According to one exemplary aspect of the present invention, the functions performed by one or more of the entities of the system, such as one or more of the terminal 10, server 22 or client 32, may be performed by various means, such as hardware and/or firmware, including those described above, alone and/or under control of a computer program product. The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIGS. 11, 17 and 18 are flowcharts, respectively, of systems, methods and program products according to exemplary embodiments of the present invention. It will be understood that each block or step of the flowcharts, and combinations of blocks in the flowcharts, may be implemented by various means, such as hardware, firmware, and/or software including one or more computer program instructions. As will be appreciated, any such computer program instructions may be loaded onto a computer or other programmable apparatus to produce a machine, such that the instructions which execute on the computer or other programmable apparatus (i.e., hardware) create means for implementing the functions specified in the block(s) or step(s) of the flowcharts. These computer program instructions may also be stored in a computer-readable memory that may direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to display an advertisement for an advertised widget on a standby screen presented by a display when the apparatus is in a standby state,
wherein the processor is configured to receive selection of the presented advertisement,
wherein the processor is configured to receive and install the advertised widget in response to receiving the selection, and
wherein the processor is configured to display an item of content provided by the installed, advertised widget on the standby screen when the apparatus is in the standby state.

2. An apparatus according to claim 1, wherein the processor being configured to display the advertisement and display the item of content includes being configured to display the advertisement and display the item of content when the apparatus is switched on or in an idle state.

3. An apparatus according to claim 1, wherein the processor is further configured to display indicia for the advertised widget on a dashboard presented by the display, the indicia being displayed after installation of the advertised widget, the dashboard including indicia for each of a plurality of widgets.

4. An apparatus according to claim 1, wherein the apparatus has another widget installed thereon, and wherein the processor is further configured to add the other widget to the standby screen, the processor being configured to display the item of content including being configured to selectively display an item of content provided by the advertised widget or other widget on the standby screen when the apparatus is in the standby state.

5. An apparatus according to claim 1, wherein the processor being configured to display the item of content includes being configured to display the item of content in a minimized view, the advertised widget being selectable to display content provided by the advertised widget in a maximized view.

6. An apparatus according to claim 1, wherein the processor being configured to display the advertisement includes being configured to selectively display an advertisement from a plurality of advertisements for a respective plurality of advertised widgets.

7. A method comprising:
displaying an advertisement for an advertised widget on a standby screen presented by a display of an apparatus when the apparatus is in a standby state;
receiving selection of the displayed advertisement;
receiving and installing the advertised widget in response to receiving the selection; and
displaying an item of content provided by the installed, advertised widget on the standby screen when the apparatus is in the standby state.

8. A method according to claim 7, wherein displaying an advertisement and displaying an item of content comprise displaying the advertisement and displaying the item of content when the apparatus is switched on or in an idle state.

9. A method according to claim 7 further comprising:
displaying indicia for the advertised widget on a dashboard presented by the display, the indicia being displayed after installation of the advertised widget, the dashboard including indicia for each of a plurality of widgets.

10. A method according to claim 7, wherein the apparatus has another widget installed thereon, and wherein the method further comprises:
adding the other widget to the standby screen,
wherein displaying an item of content comprises selectively displaying an item of content provided by the advertised widget or other widget on the standby screen when the apparatus is in the standby state.

11. A method according to claim 7, wherein displaying an item of content comprises displaying an item of content in a minimized view, the advertised widget being selectable to display content provided by the advertised widget in a maximized view.

12. A method according to claim 7, wherein displaying an advertisement comprises selectively displaying an advertisement from a plurality of advertisements for a respective plurality of advertised widgets.

13. A computer-readable storage medium of an apparatus, the computer-readable storage medium having computer-readable program code portions stored therein, the computer-readable program code portions comprising:
a first executable portion configured to display an advertisement for an advertised widget on a standby screen presented by a display when the apparatus is in a standby state;
a second executable portion configured to receive selection of the presented advertisement;
a third executable portion configured to receive and install the advertised widget in response to receiving the selection; and
a fourth executable portion configured to display an item of content provided by the installed, advertised widget on the standby screen when the apparatus is in the standby state.

14. A computer-readable storage medium according to claim 13, wherein the first and fourth executable portions being configured to display the advertisement and display the item of content includes being configured to display the advertisement and display the item of content when the apparatus is switched on or in an idle state.

15. A computer-readable storage medium according to claim 13, wherein the computer-readable program code portions further comprise:
a fifth executable portion configured to display indicia for the advertised widget on a dashboard presented by the display, the indicia being displayed after installation of the advertised widget, the dashboard including indicia for each of a plurality of widgets.

16. A computer-readable storage medium according to claim 13, wherein the apparatus has another widget installed thereon, and wherein the computer-readable program code portions further comprise:
a fifth executable portion configured to add the other widget to the standby screen,
wherein the fourth executable portion being configured to display the item of content including being configured to selectively display an item of content provided by the advertised widget or other widget on the standby screen when the apparatus is in the standby state.

17. A computer-readable storage medium according to claim 13, wherein the fourth executable portion being configured to display the item of content includes being configured to display the item of content in a minimized view, the advertised widget being selectable to display content provided by the advertised widget in a maximized view.

18. A computer-readable storage medium according to claim 13, wherein the first executable portion being configured to display the advertisement includes being configured to selectively display an advertisement from a plurality of advertisements for a respective plurality of advertised widgets.

19. An apparatus comprising:
a processor configured to receive, from a widget installed on a remote apparatus, an indication of the widget coming on-line,
wherein the processor is configured to identify the widget as being configured to provide content from a source located within an Intranet,
wherein the processor is configured to communicate with a network entity of the Intranet to authenticate the widget to receive the content in response to the identifying, and
wherein the processor is configured to receive the content from the source, and deliver the content to the widget for display on the apparatus, if the widget is authenticated.

20. An apparatus according to claim 19, wherein the processor being configured to communicate with the network entity includes being configured to sign a network address of the content with a software token of the widget, and send a request for the content to the network entity of the Intranet, the request including the signed network address, the request being sent to thereby enable the network entity to verify the signed network address to thereby authenticate the widget.

21. An apparatus according to claim 20, wherein the processor being configured to sign the network address includes being configured to sign the network address further with a cryptographic key of a cryptographic scheme implemented with the network entity.

22. A computer-readable storage medium of an apparatus, the computer-readable storage medium having computer-readable program code portions stored therein, the computer-readable program code portions comprising:
a first executable portion configured to receive, from a widget installed on a remote apparatus, an indication of the widget coming on-line;
a second executable portion configured to identify the widget as being configured to provide content from a source located within an Intranet;
a third executable portion configured to communicate with a network entity of the Intranet to authenticate the widget to receive the content in response to the identifying; and
a fourth executable portion configured to receive the content from the source, and deliver the content to the widget for display on the apparatus, if the widget is authenticated.

23. A computer-readable storage medium according to claim 22, wherein the third executable portion being configured to communicate with the network entity includes being configured to sign a network address of the content with a software token of the widget, and send a request for the content to the network entity of the Intranet, the request including the signed network address, the request being sent to thereby enable the network entity to verify the signed network address to thereby authenticate the widget.

24. A computer-readable storage medium according to claim 23, wherein the third executable portion being configured to sign the network address includes being configured to sign the network address further with a cryptographic key of a cryptographic scheme implemented with the network entity.
